(19) United States
(12) Patent Application Publication
(10) Pub. No.: US 2015/0381794 A1
(43) Pub. Date: Dec. 31, 2015

(54) VIEWING ADAPTER FOR SMARTPHONE OR SIMILIAR ELECTRONIC DEVICE

(71) Applicant: Arthur Melvin Shulenberger, Zephyr Cove, NV (US)

(72) Inventor: Arthur Melvin Shulenberger, Zephyr Cove, NV (US)

(21) Appl. No.: 14/788,559

(22) Filed: Jun. 30, 2015

Related U.S. Application Data
(60) Provisional application No. 62/018,773, filed on Jun. 30, 2014.
(60) Provisional application No. 62/099,591, filed on Jan. 5, 2015.

(51) Int. Cl. H04M 1/725; H04M 1/02

(52) U.S. Cl. CPC H04M 1/72527; H04M 1/0264

(57) ABSTRACT

A device for providing a smartphone user with improved viewing of a smartphone's display. The device has an attachment interface for mounting, holding and locating a smartphone for optimal viewing. The device includes binocular viewing optics to allow the user to comfortably view all or most of the smartphone's display simultaneously with both eyes and with significant magnification. Also incorporated into the device is an array of pushbuttons, a touchpad or both that allows the user a means to control the operation of the smartphone, since conventional access to the smartphone's touchscreen may be precluded by the housing of the device. The device communicates its control signals to the smartphone wirelessly, using one or more wireless protocols compatible with the built-in capability of the smartphone. The device includes a battery for the operation of the electronics, where said battery may be rechargeable. Optionally, the device includes an afocal magnifier lens to alter the effective focal length and hence, the apparent magnification of the built-in front-facing camera of the smartphone.

### CROSS REFERENCE TO RELATED APPLICATIONS

This application claims the benefit of U.S. Provisional Application No. 62/018,773, filed Jun. 30, 2014 and U.S. Provisional Application No. 62/099,591, filed Jan. 5, 2015.

### STATEMENT REGARDING FEDERALLY SPONSORED RESEARCH OR DEVELOPMENT

Not applicable.

### REFERENCE TO A SEQUENCE LISTING, A TABLE, OR A COMPUTER PROGRAM

Not applicable.

### COMPACT DISC APPENDIX

Not applicable.

### FIELD OF THE INVENTION

The present invention relates to smartphone accessories and more particularly to a device for connecting with a smartphone to provide improved viewing and operation during still or video image capture.

### BACKGROUND OF THE INVENTION

In recent years mobile telephones have become much more than just telephones. Advanced mobile telephones, commonly referred to as “smartphones”, have become powerful, ubiquitous computing devices, providing portable internet access, powerful computer processing ability and media storage. Such devices can access, store and play various media such as movies, photos, music, etc.

The technical capabilities of the camera(s) and display of smartphones has also been advancing rapidly, to point where a consumer's smartphone is more likely than not their primary still and video camera. With the smartphone directly connected to the internet, without any extra effort on the part of the user, the user can “instantly” upload and share captured images and video or share imagery in real time with one or more remote participants.

To the consumer, camera and display capabilities of smartphones have become “selling points” and features on par with any other capabilities and features of smartphones. Along with the camera and display other sensors and capabilities have advanced as well, including: precision location determination (built in GPS) and orientation (3 axis accelerometers, flux-gate compasses and gyroscopes).

Problems do remain for the smartphone user who is capturing still images or video, particularly when out of doors or at a large venue such as a concert. The display can suffer from “wash-out” and be difficult or impossible to see clearly when the display has direct sunlight or other intense light falling on it. Also, the as viewed resolution of the display may fall far short of the potential resolution, simply due to the (relatively) small size of the display.

### BRIEF SUMMARY OF THE INVENTION

The following summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

The present invention provides a device for improving the viewing of the display of a smartphone. The device has a means of locating and retaining the smartphone while the smartphone's display is viewed by the user through binocular viewing optics.

The device may not require significant independent computing power, but may use the computing power of the smartphone itself, thereby potentially making the device lighter and less expensive than a “stand-alone” device with the same capabilities. The camera(s), display and sensors of the smartphone may also be used to similar advantage.

The device incorporates a user interface that may include pushbuttons, touchpad(s) or both. This user interface allows the user to interact with the smartphone (including particular smartphone “apps”) in a natural-feeling and convenient manner, even though the user may not be able to touch the screen of the phone itself.

The user interface may be accomplished wirelessly through a protocol that is compatible with a built-in capability of the smartphone.

The device may be powered independently from the smartphone, with its own battery. The battery may be of a primary (non-rechargeable) type or it may be rechargeable.

### BRIEF DESCRIPTION OF THE SEVERAL VIEWS OF THE DRAWING

These and other features, aspects, and advantages of the present invention will become better understood when the following detailed description is read with reference to the accompanying drawings in which like characters represent like parts throughout the drawings, wherein:

FIGS. 1A, 1B, 1C and 1D show an assembly of a smartphone with the invention;

FIG. 2 is an oblique view of an embodiment of the invention with a smartphone in an exploded state;

FIG. 3A is an oblique view of an embodiment of the cradle assembly of the invention;

FIG. 3B is an oblique view of an embodiment of the cradle assembly of the invention in an exploded state;

FIG. 4A is an oblique view of the an embodiment of the front cover assembly of the invention;

FIG. 4B is an oblique view of an embodiment of the front cover assembly of the invention in an exploded state;

FIGS. 5A through 5H show an assembly of a smartphone into a second embodiment of the invention;

FIG. 6 is an oblique view of the second embodiment of the invention in an exploded state;

FIG. 7 is an oblique view of an embodiment of the retainer assembly of the second embodiment of the invention in an exploded state;

FIG. 8A is an oblique view of an embodiment of the touchpad assembly of the second embodiment of the invention in an exploded state;

FIG. 8B is an oblique view of an embodiment of the touchpad controller PCB assembly of the second embodiment of the invention in an exploded state;

FIG. 9 is an oblique view of the second embodiment of the invention;

FIG. 10 is an oblique view of the second embodiment of the invention;

FIG. 11A is a plan view of the second embodiment of the invention;

FIG. 11B is a front elevation view of the second embodiment of the invention;

FIG. 11C is a half-sectioned side elevation view of the second embodiment of the invention;

FIG. 12A is a half-sectioned plan view of the second embodiment of the invention;

FIG. 12B is a front elevation view of the second embodiment of the invention;

FIG. 12C is a detail view of the FIG. 12A half-sectioned plan view of the second embodiment of the invention;

FIG. 13 is an oblique view of the second embodiment of the invention;

FIGS. 14A through 14F are oblique views of embodiments of components of a third embodiment of the invention that illustrate an attachment of an external camera to the invention;

FIG. 15A is an oblique view of the third embodiment of the invention;

FIG. 15B is an oblique view of the third embodiment of the invention with an external camera attached;

FIG. 16 is an oblique view of the third embodiment of the invention, shown in separated relation to the face and head of a user who is wearing glasses;

FIG. 17 is an oblique view of the third embodiment of the invention, shown in close relation to the face and head of a user who is wearing glasses;

FIG. 18A is a detail oblique view of the third embodiment of the invention, shown in close relation to the face and head of a user who is wearing glasses;

FIG. 18B is another detail oblique view of the third embodiment of the invention, shown in close relation to the face and head of a user who is wearing glasses;

FIG. 19A is a plan view of the first embodiment of the invention;

FIG. 19B is a plan view of the second embodiment of the invention; and

FIG. 20 is a representation of an appearance of the display, as seen by the user.

FIG. 21A is a plan view showing an embodiment of the relationships between the eyelenses, the user's eyes and the smartphone's display.

FIG. 21B is a half-sectioned plan view of the eyelens, relating to the section line shown in FIG. 21C.

FIG. 21C is a front elevation view of the eyelens.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions are made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

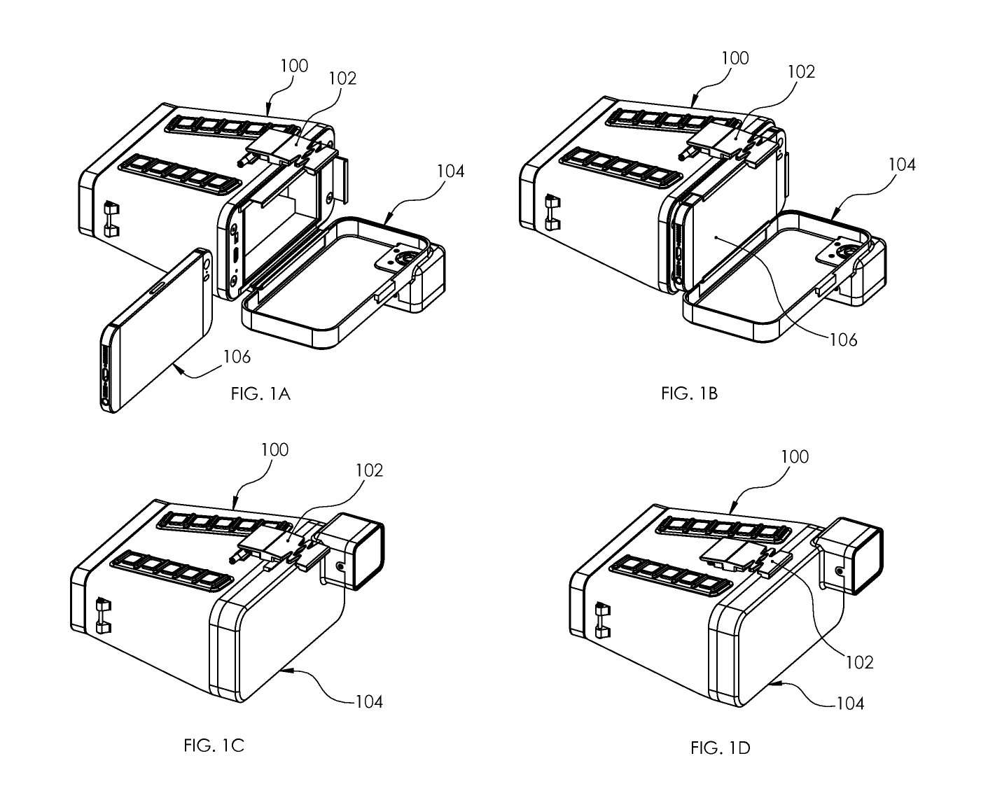

FIG. 1A through 1D represent a sequence of actions associated with an exemplary embodiment of preparing the invention for use.

With reference to FIG. 1A, an exemplary viewing adapter device 100 having a latch 102 and a front cover assembly 104 is shown with front cover assembly 104 tilted forward and latch 102 released so as to be ready to receive a smartphone 106.

FIG. 1B shows the aforementioned components after the smartphone 106 has been moved fully into its operating position but with the front cover assembly 104 still tilted forward and the latch 102 still disengaged. The placement and location of the smartphone 106 may be aided by guiding rails and a stop surface where these guiding and locating surfaces may be appropriately relieved to accommodate protruding features, such as pushbuttons, that are built into the design of the smartphone 106.

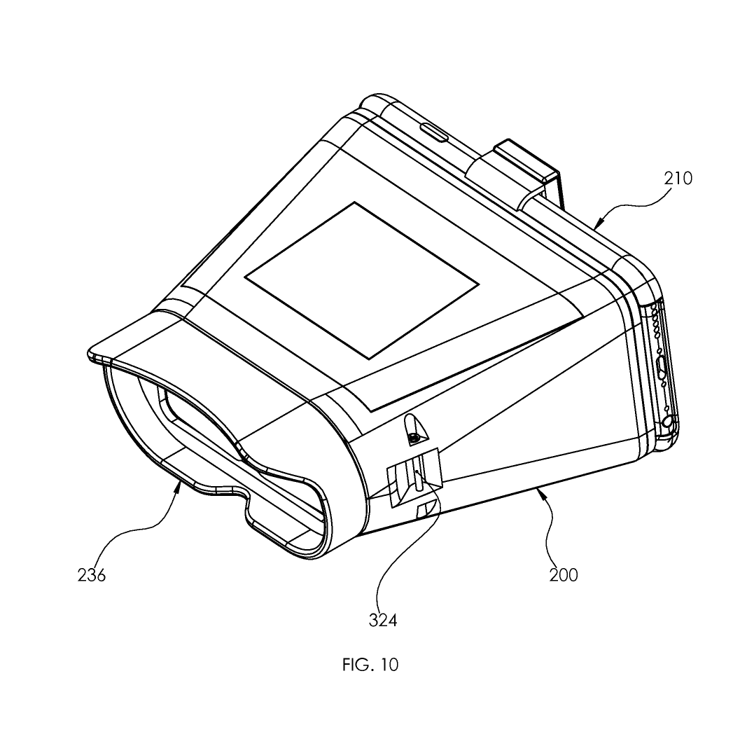

FIG. 10 shows the exemplary embodiment of the invention, after having received the smartphone 106 with the front cover assembly 104 raised but not yet secured by the latch 102. The front cover assembly 104 may include a slide stop feature that acts to locate the smartphone 106 by occupying space behind the smartphone 106 when the front cover assembly 104 is in its closed position.

FIG. 1D shows the exemplary embodiment of the invention, now with the smartphone 106 fully inserted and secured by movement of the latch 102.

Note that removal of the smartphone 106 from the adapter device 100 will typically entail the reversal of these steps.

Note that mating surfaces, such as between the front lid assembly 104 and the rest of the viewing adapter device 100, may incorporate gasketing, sealing materials, sealing surfaces and the like to reduce or eliminate ingress of water, air or other fluids or unwanted substances into the interior of the viewing adapter device 100 when it is closed. Spaces between other surfaces where components may move or not move relative to adjacent surfaces may also, similarly, be provided with sealing means. Over and/or under pressure relief means may also be incorporated into the invention to accommodate for changes in environmental pressures.

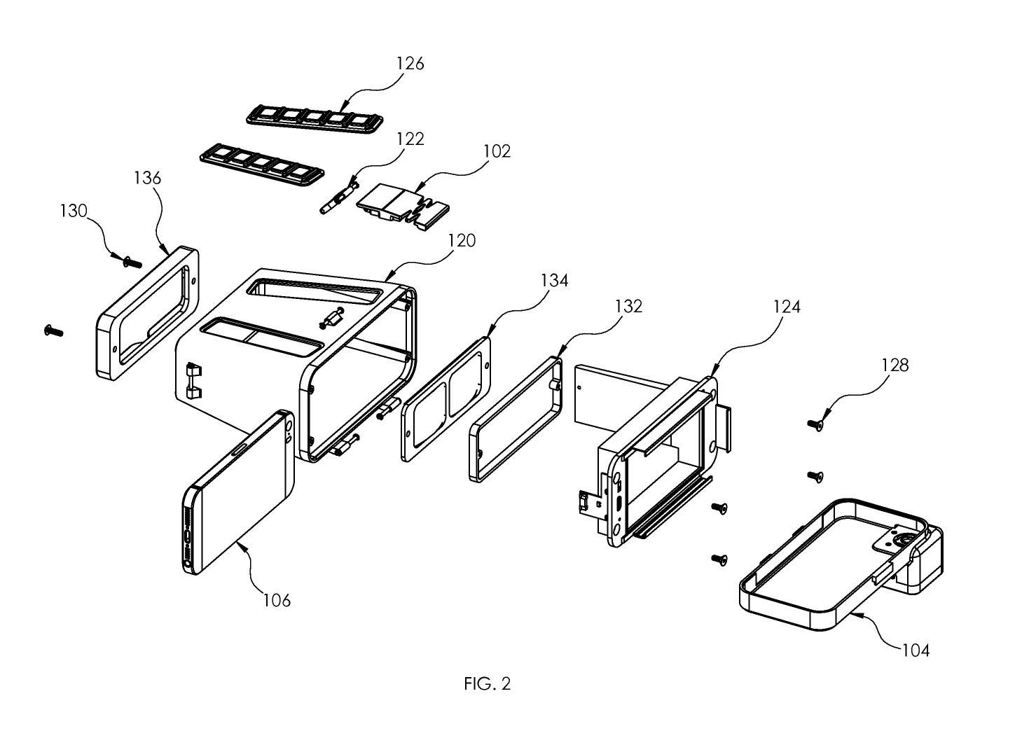

FIG. 2 shows an exemplary embodiment of the invention in an exploded state. Latch 102 attaches in hinged fashion to link 122 which in turn attaches, also in hinged fashion, to the housing 120. The eyelens assembly 134 is captured to the housing 120 by the eyelens retainer 132 having received screw(s) 130 that pass through face adapter 136. Cradle assembly 124 is attached to housing 120 by means of screw(s) 128. Front cover assembly 104 is attached in hinged fashion to housing 120, and switch assembly(s) 126 are bonded or otherwise attached to housing 120. Smartphone 106 is shown for reference only and may not be permanently assembled to the viewing adapter device 100.

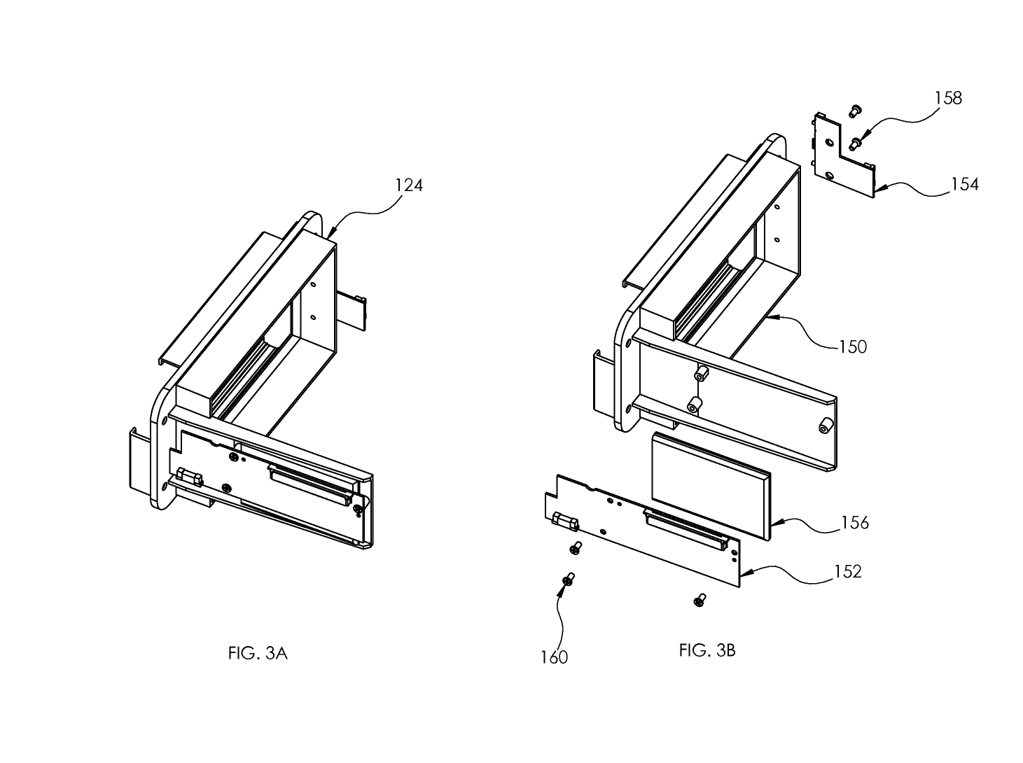

FIG. 3A is an oblique view of an exemplary embodiment of cradle assembly 124 of the invention and FIG. 3B shows the cradle assembly 124 of the invention in an exploded state where a battery 156 is captured between cradle 150 and main PCB 152 when assembled with screw(s) 160. Secondary PCB 154 is attached to cradle 150 by screw(s) 158. Battery 156, main PCB 152, secondary PCB 154 are interconnected with wiring (not shown) which also connects to switch assembly(s) 126. The main PCB 154 may include components to support the battery charging function (if battery 156 is rechargeable), the wireless communication function and the switch input decoding function. The secondary PCB 154 may incorporate a charging and diagnostics port as well as power switch and status indicator light(s).

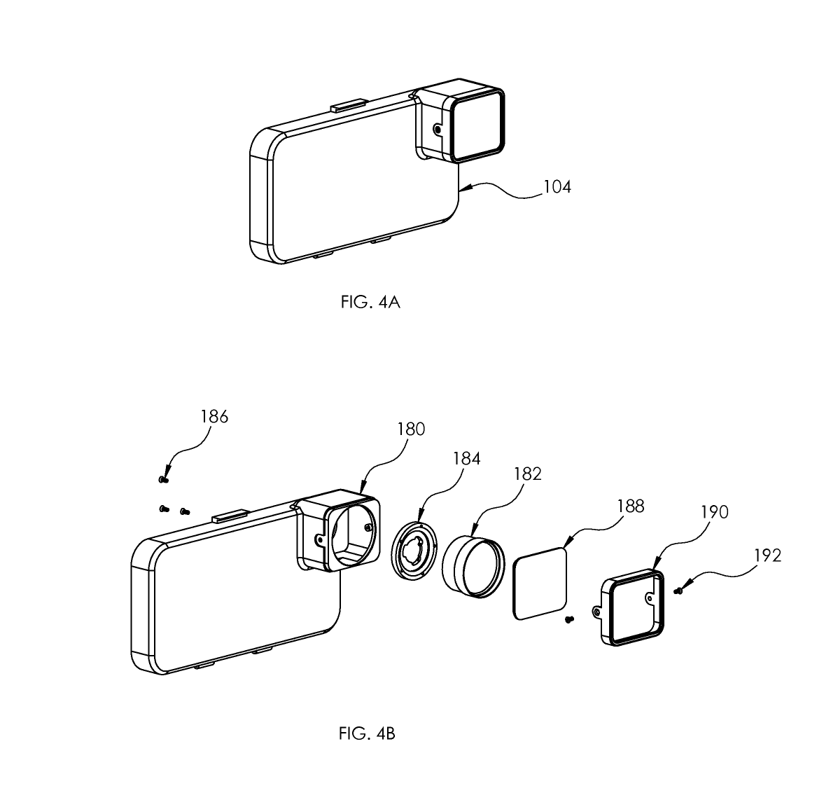

FIG. 4A is an oblique view of the front cover assembly 104 of an embodiment of the invention and FIG. 4B shows the front cover assembly 104 of the invention in an exploded state where afocal magnification lens 182 is attached to lens adapter 184 which is mounted to front cover shell 180 with screw(s) 186. Window 188 and frame 190 are attached to front cover shell 180 with screw(s) 192. The afocal magnification lens 182 may have a magnifying power of about 2×, although magnification powers greater than and less than 2× are also contemplated, to “bring distant objects closer” than they would be perceived by the smartphone 106 front facing camera without the afocal magnification lens 182.

Embodiments of the window 188 and frame 190 as it interfaces to the front cover shell 180 may incorporate fluid tight sealing means to prevent ingress of fluids, etc. when the viewing adapter device 100 is in use.

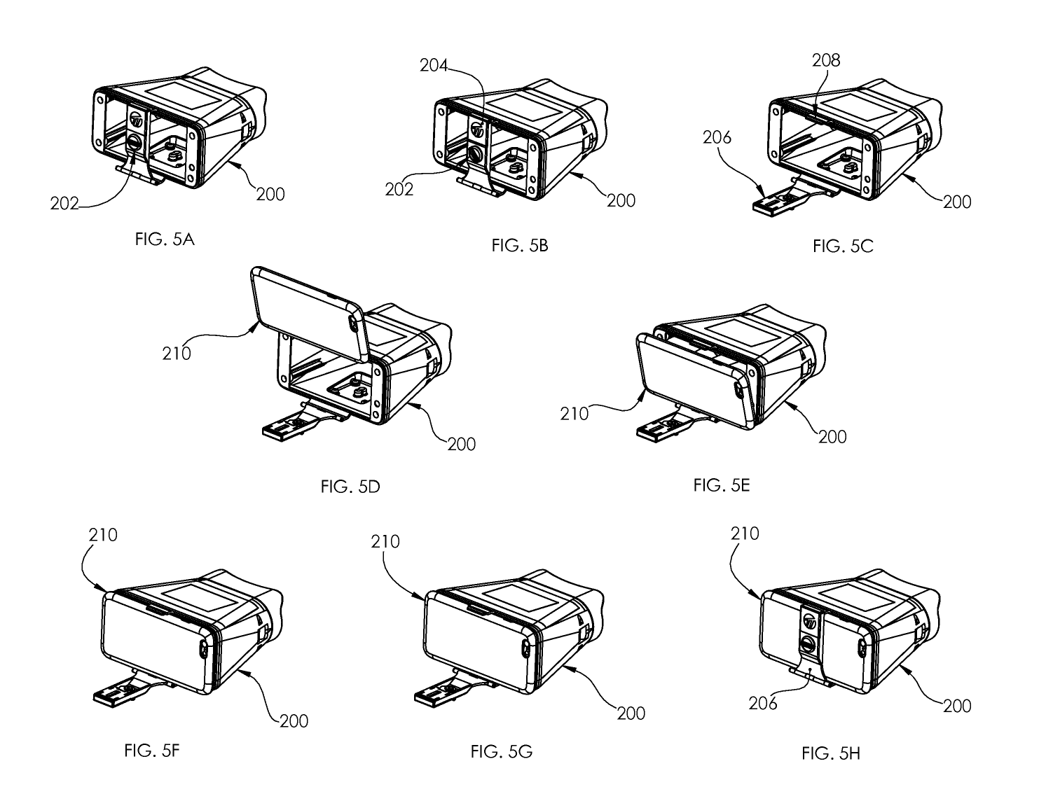

FIGS. 5A through 5H shows a second embodiment of the invention, and the assembly of a smartphone with cover 210 ito viewing adapter device 200 in a set of sequential steps.

FIG. 5A shows the viewing adapter device 200 in a closed position without a smartphone with cover 210 in place. Lever 202 is indicated and shown in its unreleased position. FIG. 5B shows the lever 202 rotated approximately 45 degrees clockwise and causing the latch 204 to be moved, thereby disengaging the latch 204 from the catch 208 shown in FIG. 5C where the retainer arm assembly is now shown in forward rotated position, ready to receive smartphone with cover 210. FIG. 5D shows smartphone with cover 210 being brought into alignment with viewing adapter device 200 and FIG. 5E shows the smartphone with cover 210 having its lower edge engaged with viewing adapter device 200. FIG. 5F shows smartphone with cover 210 rotated parallel to but slightly separated from viewing adapter device 200. FIG. 5G shows smartphone with cover 210 now fully engaged to viewing adapter device 200 but not secured. FIG. 5H shows smartphone with cover 210 now secured to viewing adapter device 200 by having rotated retainer arm assembly 206 such that latch 204 engages catch 208.

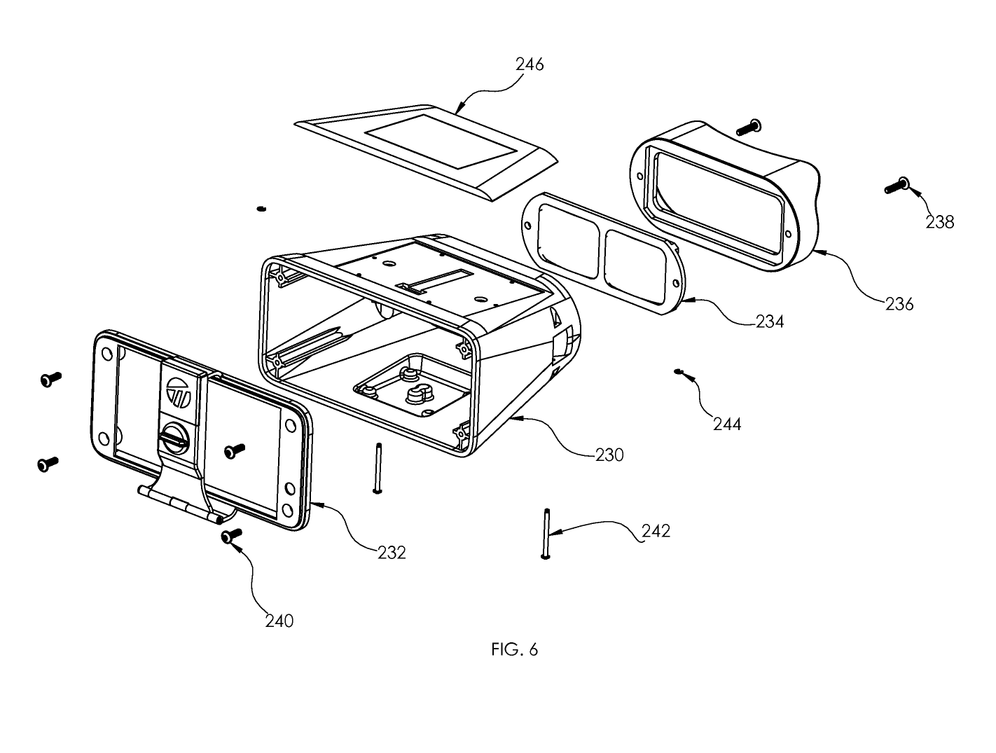

FIG. 6 is an oblique view of an embodiment of viewing adapter device 200 in an exploded state where eyelens assembly 234 is captured by face adapter 236 which is held in place by screw(s) 238 screwed into housing 230. Pin with retaining clip 242 is inserted into housing 230 and held in place with retaining clip 244, thereby, along with a recess in housing 230, providing an attachment point for a neck strap (not shown) on both sides of the viewing adapter device 200. Touchpad assembly 246 is attached to housing 230 by adhesive or screws (not shown). Retainer assembly 232 is attached to housing 230 by screw(s) 240.

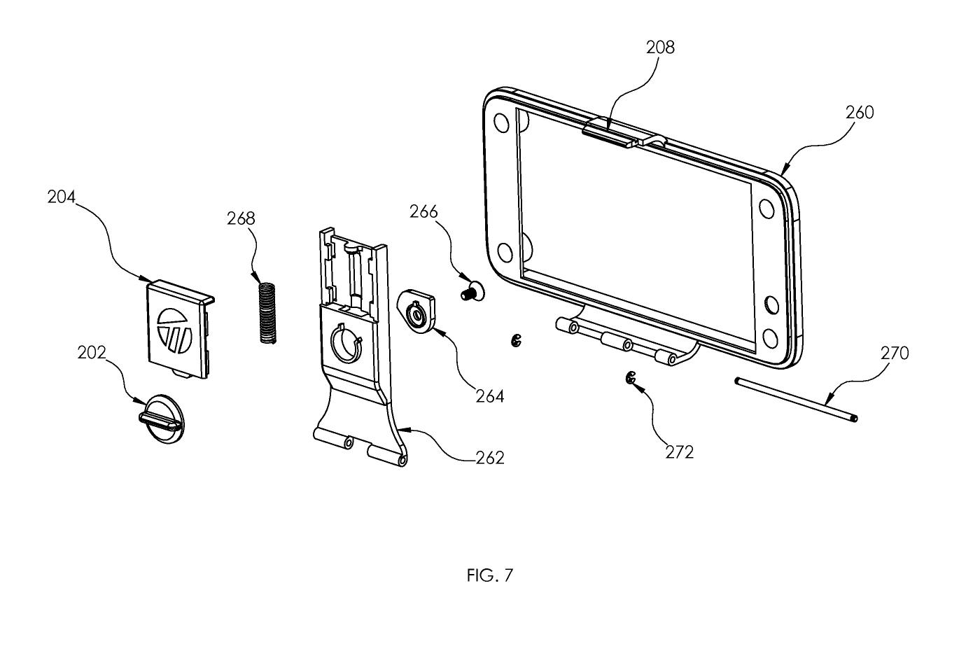

FIG. 7 is an oblique view of an embodiment of retainer assembly 232 in an exploded state where retainer arm assembly 206 is also in an exploded state. Nest body 260 and retainer arm 262 are attached together hinge-wise by pin 270 which is retained by retaining clip(s) 272. Cam 264 is mounted to lever 202 with screw 266 so as to allow a limited rotational movement of about 45 degrees. Assembly of cam 264 and lever 202 captures latch 204 and spring 268. Spring 268 acts between retainer arm 262 and latch 204 to move the latch 204 in a downwards direction as it appears in this view, while rotating the cam 264 and lever 202 to the position they are shown in in this view. Action of spring 268 allows the retainer arm assembly 206 to “snap” firmly into place when latch 204 engages catch 208. Rotation of lever 202 releases the retainer arm assembly 206 from its “closed” position.

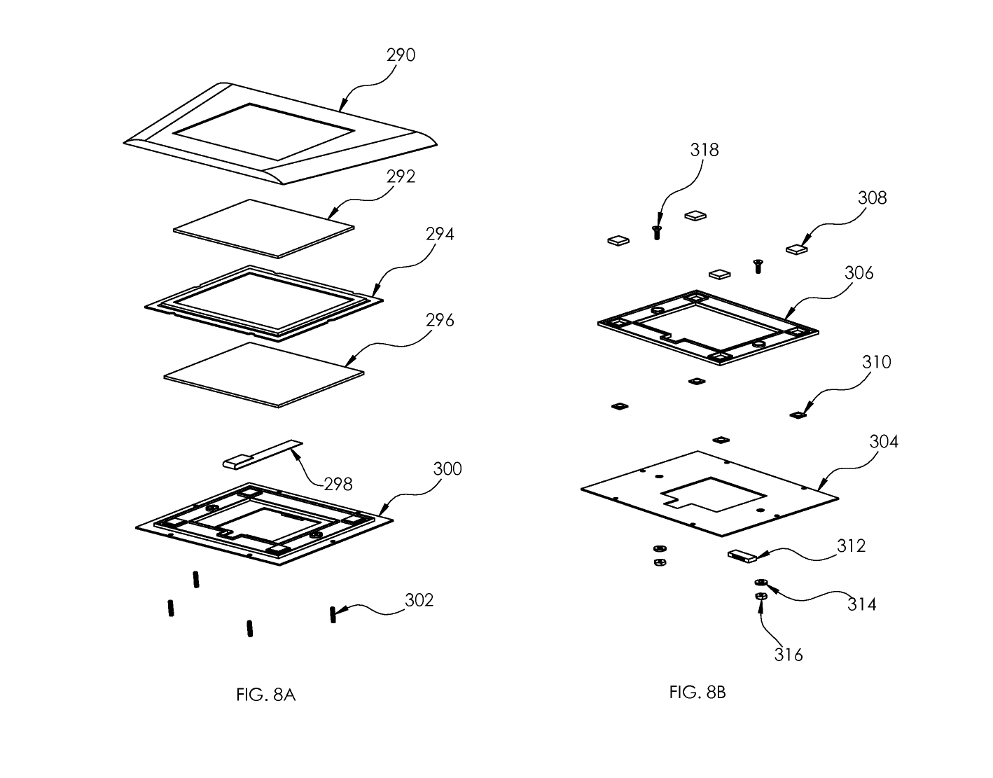

FIG. 8A is an oblique view of an embodiment of touchpad assembly 246 in an exploded state where a number of components are assembled (e.g. sandwiched) together. Surface spacer 292 and flexible gasket 294 are bonded, or otherwise affixed, to touchpad 296 and flexible gasket 294 is also bonded, or otherwise affixed, to touchpad bezel 290. Stud(s) 302 may be screwed into touchpad bezel 290 providing alignment for touchpad controller PCB assembly 300. A flat flexible cable (FFC) 298 may provide electrical connections between the touchpad 296 (at a connector not shown) and the touchpad controller PCB assembly 300. Touchpad assembly 246 may be attached to housing 230 by nuts (not shown) that thread onto stud(s) 302.

FIG. 8B is an oblique view of an embodiment of touchpad controller PCB assembly 300 in an exploded state where switch(s) 310 and electrical connector 312 are soldered to touchpad controller PCB 304. Switch button(s) 308 are captured in open guideways in switch button frame 306. Screw(s) 318, washer(s) 314 and nut(s) 316 hold the stack of components together for assembly into touchpad assembly 246 where the components may be further constrained. Connector 312 interfaces with one end of flat flexible cable (FFC) 298. Other electrical connections may be provided to a battery (not shown) and charging connector (not shown), etc. Components for providing a wireless interface to the smartphone with cover 210 may be mounted on touchpad controller PCB 304 or on another PCB (not shown). In an exemplary operation, touching the surface spacer 292 results in a position reporting signal being sent to the smartphone with cover 210 and pressing down on surface spacer 292 at any point on its exposed surface results in a switch closure signal being transmitted. Alternatively, the design may incorporate a rigidly fixed touchpad, with or without pushbutton switches, facilitating the use of a tap or other gesture as an alternative or in addition to a pressing action. A rigidly mounted touchpad may also incorporate “force sensing” technology, providing pressure as well as location data when there is a touch input to the touchpad. Haptic feedback means may also be combined with user input devices of either pushbutton or touchpad types so as to improve user experience and/or to provide special or typical tactile feedback to the user.

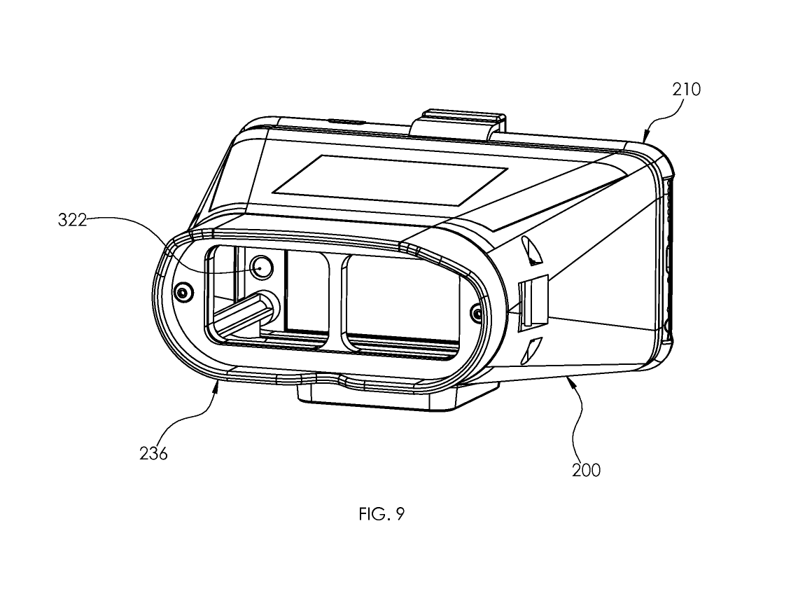

FIG. 9 is an oblique view from the viewing direction of an embodiment of viewing adapter device 200 having smartphone with cover 210 in place, suitable for operation. Face adapter 236 is seen at the near end of viewing adapter device 200. The display of the smartphone is seen through the eyelenses of viewing adapter device 200. Also seen through the left eyelens is smartphone display-side camera 322 which is exposed by the fact that it is in alignment with a hole in nest body 260. This arrangement may enable the implementation of eye-tracking during use of the invention. Data from eye-tracking may be used to determine the user's point-of-interest on the smartphone's display. This point-of-interest data may be used in real time to direct automatic focusing, exposure, zoom or other front-facing camera functions. Similar interactions with non-real time imagery presented to the user is also enabled, such as eye-tracking panning of imagery in a 360 degree panorama.

FIG. 10 is top-rear oblique view of an embodiment of viewing adapter device 200 having smartphone with cover 210 in place, suitable for operation. Neck-strap attachment point 324 is shown as is the relief in housing 230 for neck-strap attachment. An exemplary shape of face adapter 236 is seen here, including protrusions and reliefs described later.

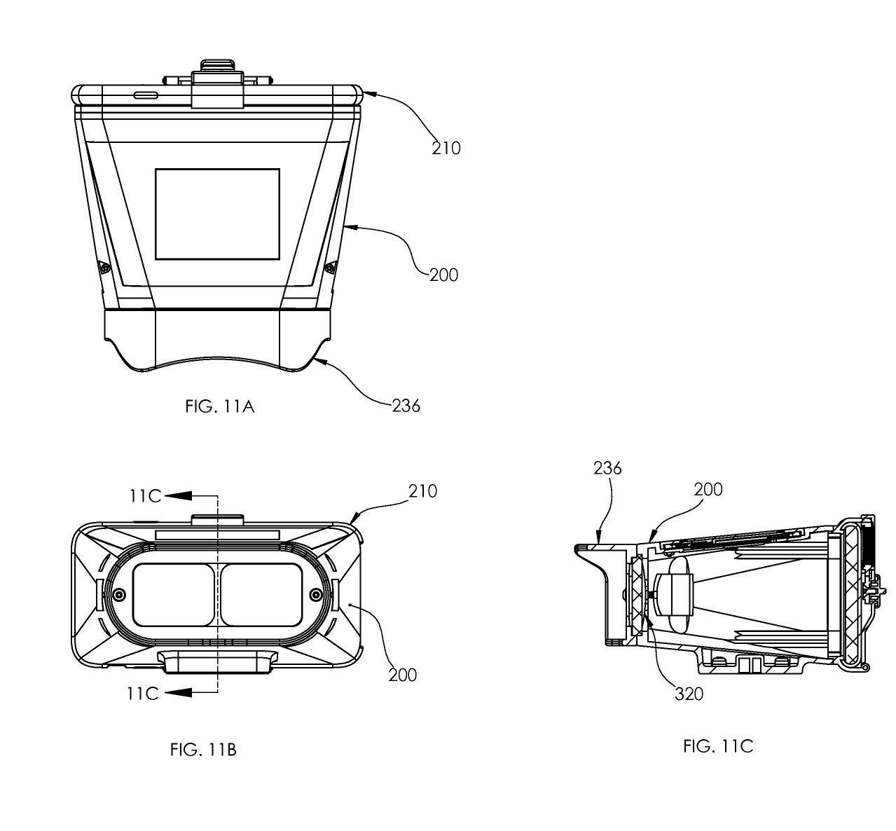

FIG. 11A is a plan view of an embodiment of viewing adapter device 200 having smartphone with cover 210 in place, suitable for operation. An exemplary shape of the top edge of face adapter 236 is seen clearly here.

FIG. 11B is an elevation view from the viewing direction of an embodiment of viewing adapter device 200 having smartphone with cover 210 in place, suitable for operation. Two separate exemplary viewing lenses are seen here.

FIG. 11C is a half section side elevation view of an embodiment of viewing adapter device 200 having smartphone with cover 210 in place, suitable for operation, the section line being shown in FIG. 11B. The (left) eyelens 320 is seen here as well as an exemplary shape of the face adapter 236.

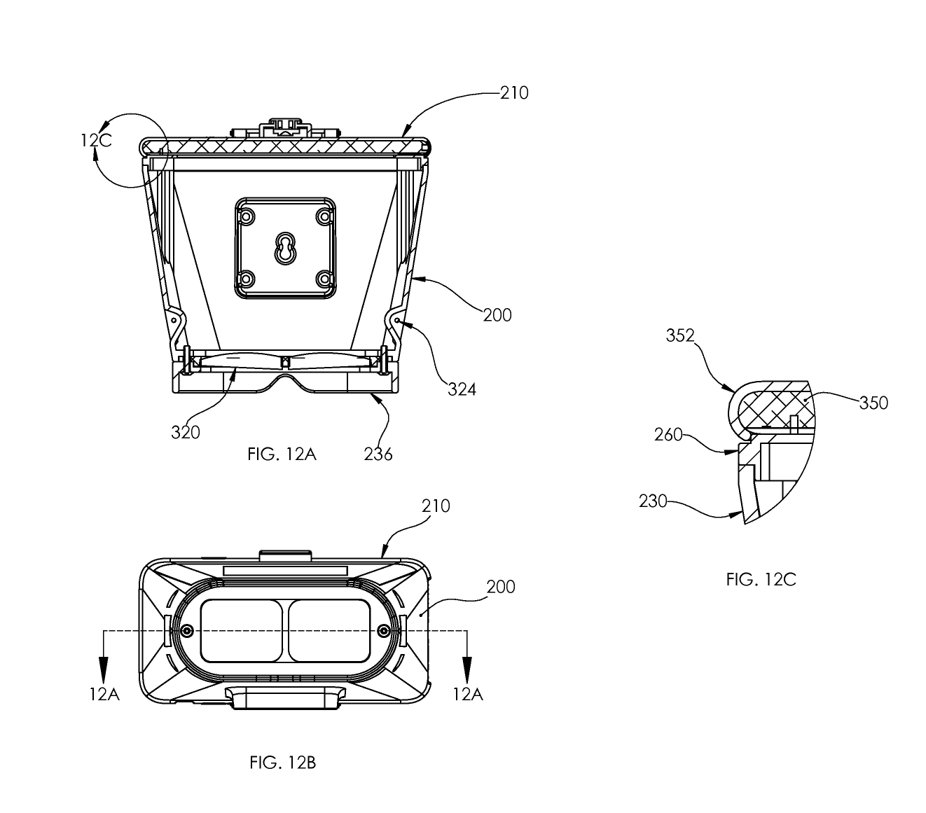

FIG. 12A is a half section top plan view of an embodiment of viewing adapter device 200 having smartphone with cover 210 in place, suitable for operation, the section line being shown in FIG. 12B. Exemplary shape and orientation of (both) eyelens(s) 320 is seen here along with the nose relief in face adapter 236. The relief in housing 230 at neck-strap attachment point 324 is seen here. Exemplary eyelens(s) 320 are also seen to be wedge-shaped and angled towards their mid-line. Exemplary eyelens 320 is plano-convex with an effective focal length of about 100 mm, although other focal lengths are contemplated, and is comprised of a moldable, low-dispersion glass so as to be manufacturable by molding at a low cost with high quality. The exemplary lens arrangement as shown allows comfortable viewing without interocular lens separation for most users. The lens focal length and distance to the smartphone's display is such that the apparent viewing distance and focusing required for the user's eyes allows the user to view the smartphone's display interchangeably with distance viewing. If the user wears glasses (or contact lenses) for distance viewing they will be able to view the smartphone's display with those glasses. If the user doesn't use glasses for distance viewing, they will view the smartphone's display without glasses.

FIG. 12B is an elevation view from the viewing direction of an embodiment of viewing adapter device 200 having smartphone with cover 210 in place, suitable for operation.

FIG. 12C is a detail view presenting a portion of FIG. 12A at a larger scale. The display-side face of smartphone 350 held snugly against nest body 260 while a step incorporated into the design of nest body 260 locates the smartphone 350 laterally by engaging with the inner edge of smartphone cover 352. Nest body 260 has a step on the side opposite the smartphone 350 that engages the housing 230.

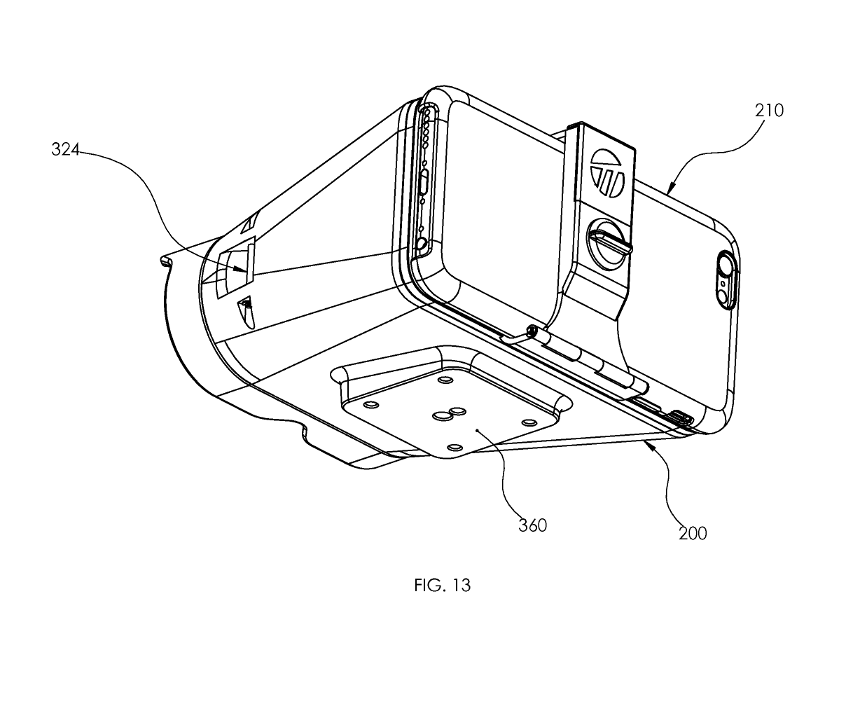

FIG. 13 is an oblique view from the smartphone with cover 210 attachment and bottom viewing direction of viewing adapter device 200 having smartphone with cover 210 in place, suitable for operation. Neck-strap attachment point 324 is seen in this view. The surface of attachment interface 360 is shown. Attachment interface 360 provides a flat and horizontal mounting surface to facilitate attachment of viewing adapter device 200 to various mounts including conventional photographic tripods.

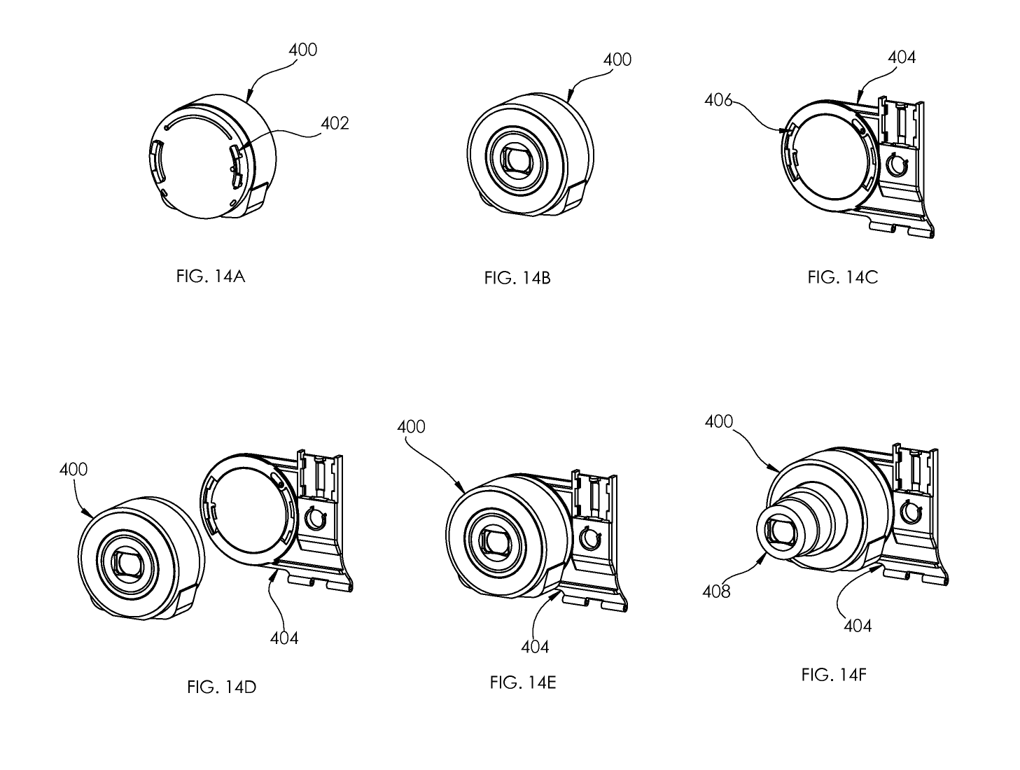

FIG. 14A shows the rear, mounting interface side of an embodiment of a detachable camera 400 which includes an exemplary mounting interface on camera detail 402 comprising a set of radially arranged tabs.

FIG. 14B shows the front, lens side of an embodiment of a detachable camera 400 in a fully retracted or standby state.

FIG. 14C shows exemplary retainer arm with camera interface 404 having attachment detail 406. Retainer arm with camera interface 404 can be directly substituted for previously described retainer arm 262 thereby providing the capability to mount detachable camera 400.

FIG. 14D shows an embodiment of a detachable camera 400 aligned but separated from retainer arm with camera interface 404.

FIG. 14E shows an embodiment of a detachable camera 400 mounted to retainer arm with camera interface 404. The mounting operation is accomplished by matching the protrusions of mounting interface on camera 402 with the recesses of attachment detail 406, fully inserting these details together and then rotating the full body of detachable camera 400 till a spring-loaded pin in detachable camera 400 engages a matching hole that is incorporated into attachment detail 406. Removal of the detachable camera 400 requires the movement of a lever on the body of the detachable camera 400 to disengage said pin, and with the pin disengaged, the detachable camera 400 body is rotated in the opposite direction of its rotation for attachment to detach it.

FIG. 14F shows an embodiment of a detachable camera 400 with extended camera lens 408 fully extended and mounted to retainer arm with camera interface 404.

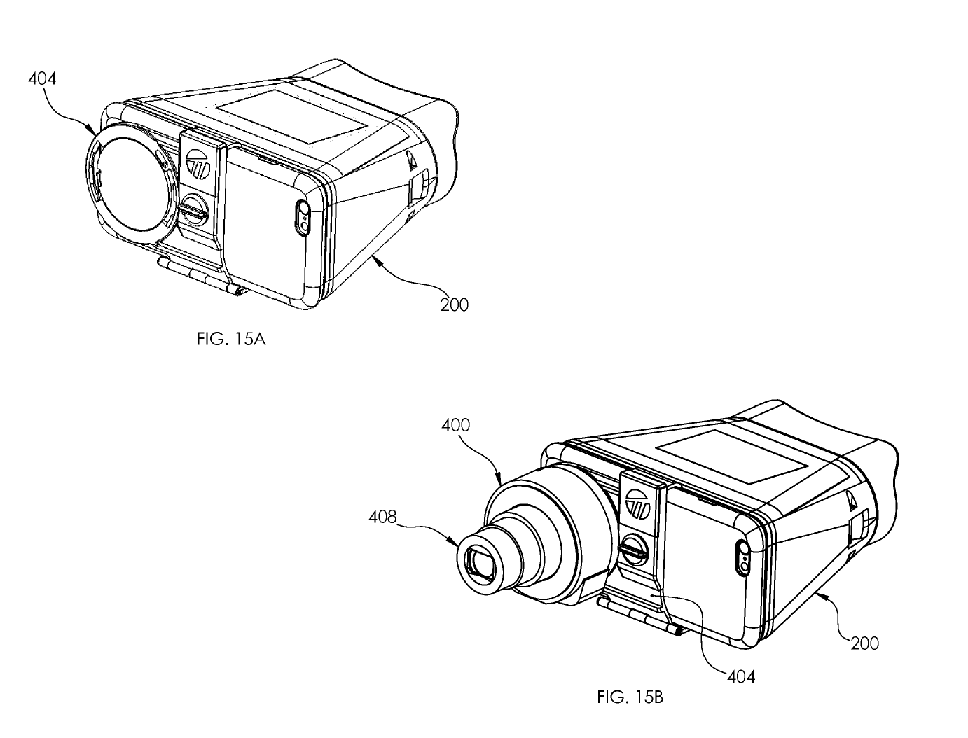

FIG. 15A is a smartphone-side oblique view of an embodiment of viewing adapter device 200 with retainer arm with camera interface 404 substituted for retainer arm 262.

FIG. 15B is a smartphone-side oblique view of an embodiment of viewing adapter device 200 with detachable camera 400 mounted. Extended camera lens 408 is fully extended representing operational mode.

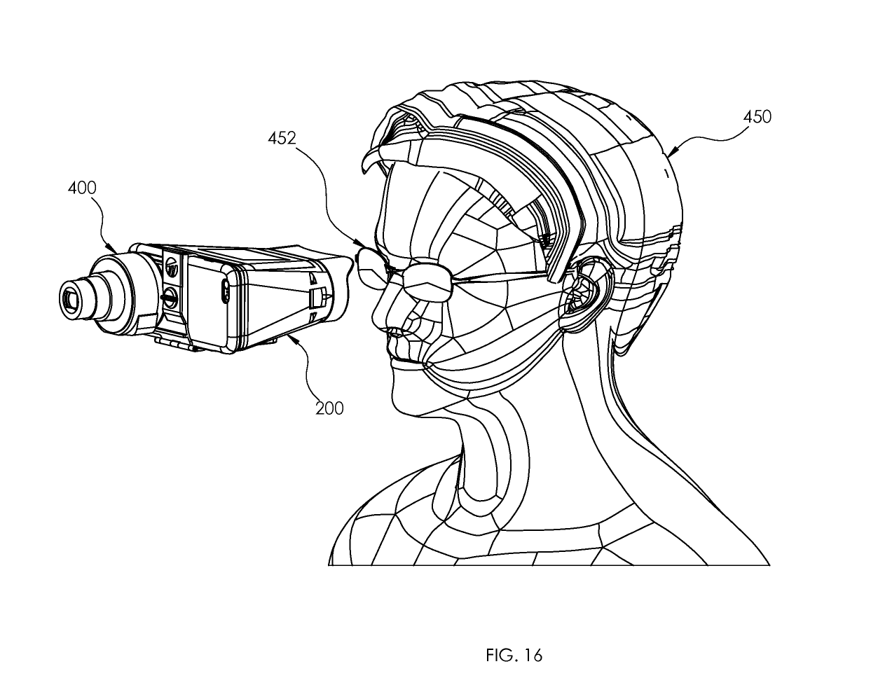

FIG. 16 is a smartphone-side oblique view of an embodiment of viewing adapter device 200 with detachable camera 400 mounted shown aligned with but separated from the face of a person 450 with eyeglasses 452.

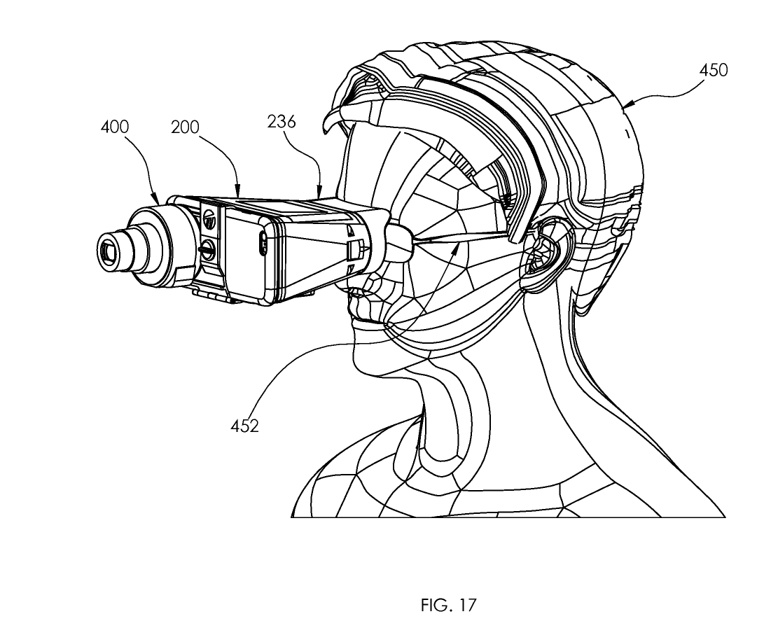

FIG. 17 is a smartphone-side oblique view of an embodiment of viewing adapter device 200 with detachable camera 400 mounted shown aligned and close to the face of a person 450 with eyeglasses 452.

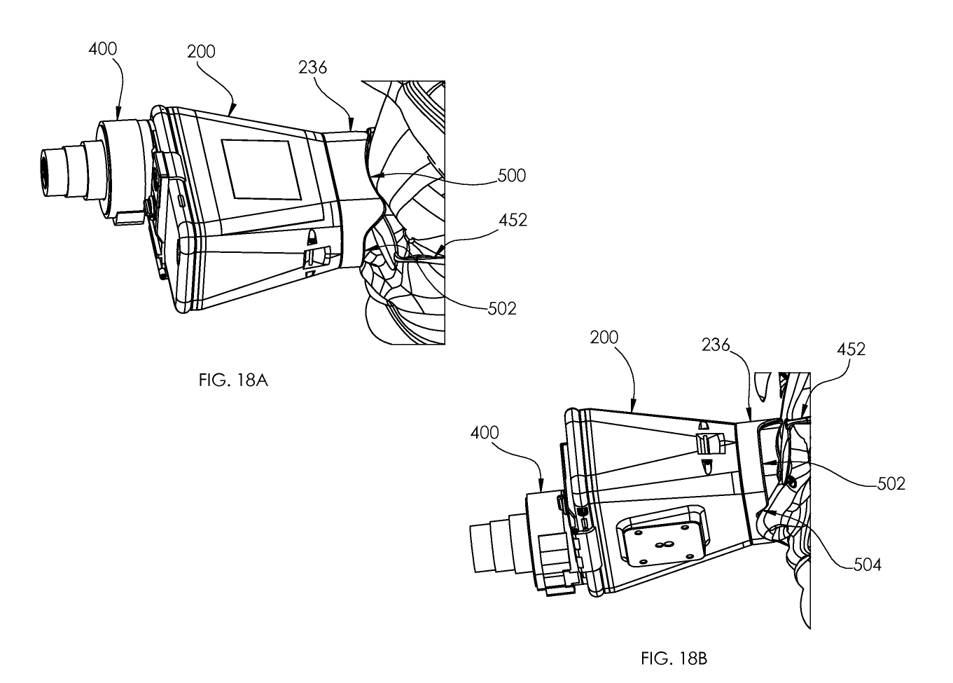

FIG. 18A shows the arrangement of FIG. 17 but from a downward-looking viewpoint. Note that face adapter 236 includes exemplary detail forehead conformal curve 500.

FIG. 18B shows the arrangement of FIG. 17 but from an upward-looking viewpoint. Note that face adapter 236 includes exemplary eyeglasses side relief 502 and nose relief 504 details.

The combination of forehead conformal curve 500, eyeglasses side relief 502 and nose relief 504 provides face adapter 236 with an optimized capability to provide: shielding from ambient light, alignment and positioning of the viewing adapter device 200 in use, stabilization of viewing adapter device 200 when it is in contact with the face of a person 450, and the freedom for the user to wear their eyeglasses 452. Face adapter 236 may be comprised of or otherwise incorporate soft and/or flexible, or other suitable, materials to further enhance its function as contacting surface with the face of the user.

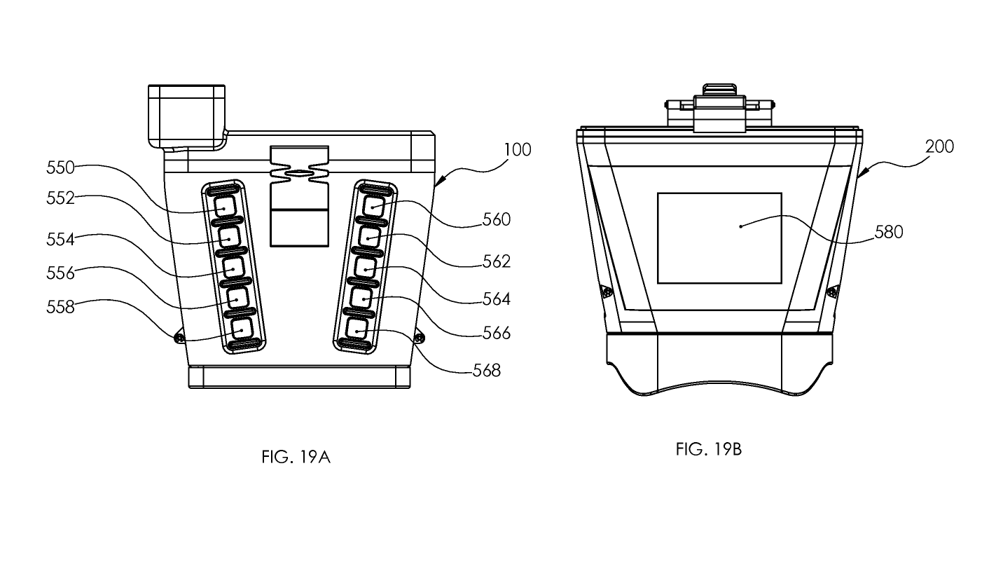

FIG. 19A is a top plan view of an embodiment of viewing adapter device 100 showing exemplary physical button one 550 through physical button ten 568 arranged in two groups of five each linearly disposed towards the upper side corners of viewing adapter device 100.

FIG. 19B is a top plan view of an embodiment of viewing adapter device 200 showing exemplary touchpad active area 580 as it is centrally located on the top surface of viewing adapter device 200.

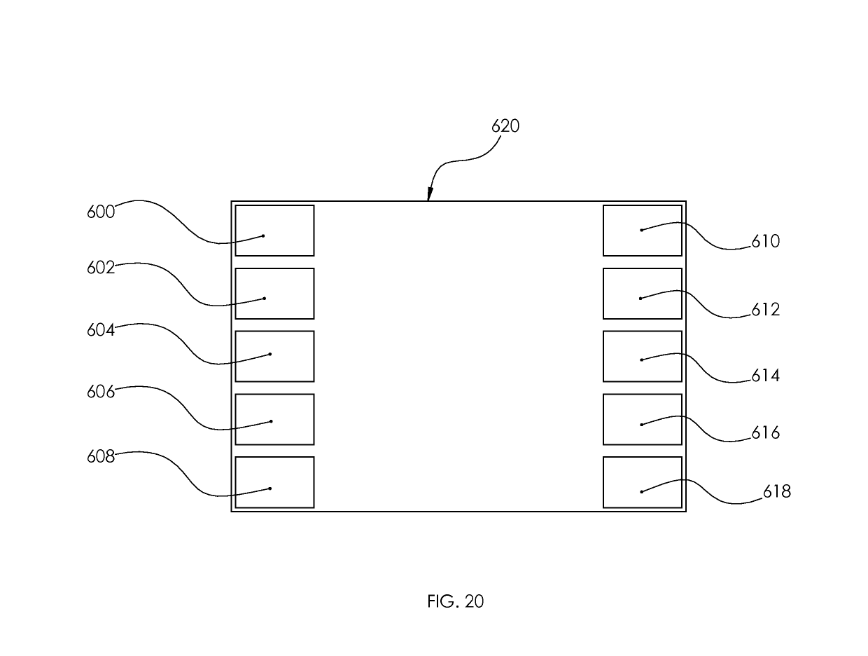

FIG. 20 shows the smartphone's display area 620 and an exemplary embodiment of how virtual button one 600 through virtual button ten 618 may be incorporated into the information display of the smartphone.

In an exemplary embodiment of the invention having physical buttons, physical button one 550 through physical button ten 568 may be mapped to functions indicated by the display states of virtual button one 600 through virtual button ten 618. Physical buttons may incorporate capacitive touch or other suitable sensing means, such as optical reflection or beam interruption, to allow the software of the smartphone to be notified that a button is being touched, but not pressed. This “touched but not pressed” state may be indicated on the display by highlighting of touched button(s) of the smartphone for clear feedback to the user, since user will not be able to see their hands while viewing with the invention.

In an exemplary embodiment of the invention without physical buttons that map to the smartphone display, the user's touch on the touchpad active area 580 may be substituted for a touch on the touchscreen of the smartphone itself. The X-Y grid of the touchpad active area 580 may be mapped 1:1 to the smartphone's display area 620 to provide the user with a familiar and easy to use control interface. A “cursor” or other visual indication of one or multiple touches may be provided on the smartphone's display. Tapping or firmly pressing on the touchpad active area 580 may substitute for the commonly used “touch up inside” means for activating a button within the software of the smartphone.

Physical buttons may be combined with a touchpad in another embodiment of the invention. In an exemplary embodiment the operation of physical buttons may be communicated to the smartphone using a standard wireless keyboard protocol, while touchpad input may be communicated to the smartphone using a standard wireless trackpad protocol, although other means of communication are also contemplated.

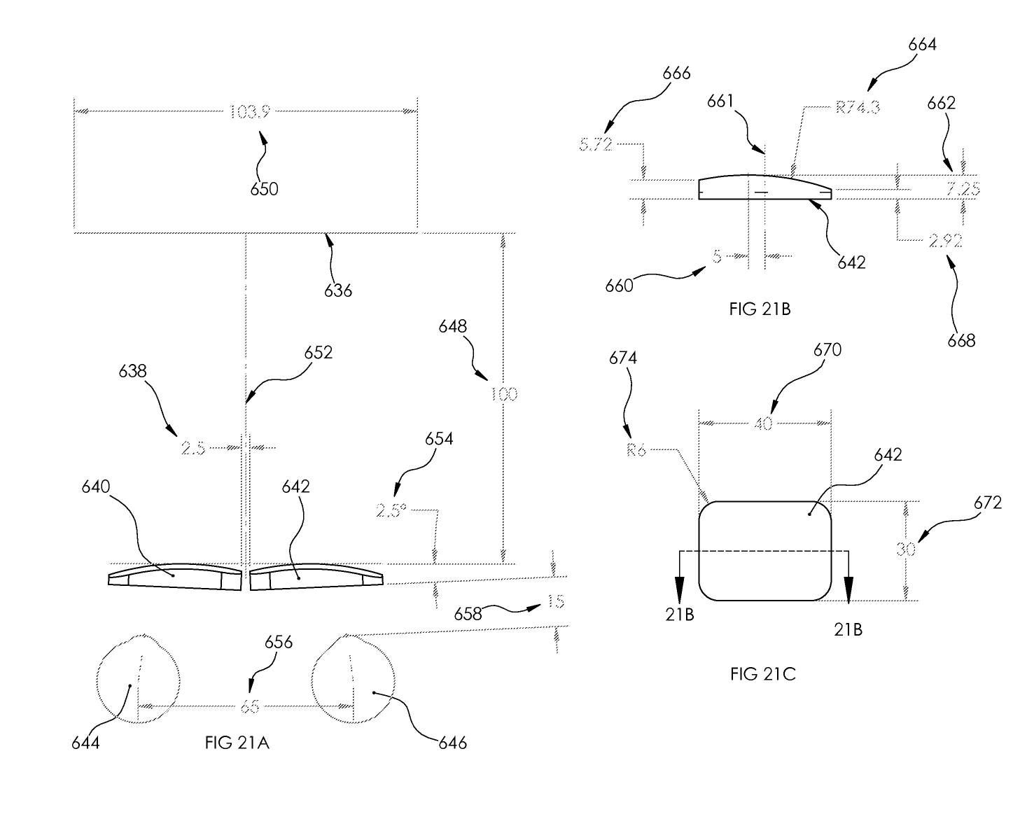

FIG. 21A shows the viewing optics of an exemplary embodiment of the invention where a left eyelens 640 and a right eyelens are symmetrically opposed across an axis of symmetry 652 with an eyelens separation distance 638 of 2.5 mm. Both eyelenses are planoconvex with the flat (plano) side of each eyelens at an eyelens tilt 654 angle of 2.5 degrees from perpendicular to the axis of symmetry 652. The pair of eyelenses are located with an eyelens to smartphone separation distance 648 of 100 mm between the pair of eyelenses and the smartphone display surface 636 which is perpendicular to the axis of symmetry 652 and has a smartphone display width 650 dimension of 103.9 mm. The user's left eye 644 and right eye 646 are shown with an interocular distance 656 of 65 mm and an eye relief 658 of 15 mm.

FIG. 21B is a horizontal cross-section of the exemplary right eyelens 642 showing a center thickness 662 of 7.25 mm, and inner edge thickness 666 of 5.72 mm and an outer edge thickness 668 of 2.92 mm. The convex surface of the lens has a radius of curvature 664 of 74.3 mm with an offset distance 660 of 5 mm between the center of curvature (and horizontal point of tangency) and the lens mid-plane 661.

FIG. 21C is an elevation view of exemplary right eyelens 642 showing a eyelens width dimension 670 of 40 mm, an eyelens height dimension 672 of 30 mm and an eyelens corner radius 674 dimension of 6 mm.

The two exemplary eyelenses are of identical design to each other and are constructed of moldable low dispersion glass and rigidly fixed in a common housing. Alternatively, the lenses may be constructed of plastic or other suitable optical material (instead of moldable low dispersion glass), they may be adjustable as to separation distance, they may have anti-reflection or other coatings and they may each be comprised of differing optical materials so as to minimize chromatic aberrations. In another alternative, the lenses may incorporate aspherical surfaces, fresnel type surfaces or holographic imaging surfaces.

The exemplary detachable camera 400 may communicate with the invention and/or smartphone using wireless interfaces such as wi-fi, NFC and Bluetooth and/or hardwired electrical and optical data transport means. Mounting of the detachable camera 400 may be sensed and specific configuration, and other, information about the detachable camera 400 may be communicated to automatically configure the smartphone's software to operate with the particular camera unit.

In some embodiments of the invention, the smartphone mounting interface, such as cradle assembly 124 and retainer assembly 232, may be a modular component of a complete viewing adapter device assembly where a variety of specific smartphone mounting interface designs are produced to support the use of smartphones of varying models from multiple manufacturers with a more limited number of main viewing adapter device housing assemblies.

As an alternative, or in addition, to the detachable camera 400 as shown, one or more cameras may be incorporated into the housing or the smartphone mounting interface of the invention. In some embodiments a pair of cameras, or a single camera, suitably located relative to the smartphones front-facing camera with, for example, an approximately 65 mm horizontal separation can be used to capture stereoscopic images or video for later “3D” playback or viewing. Larger horizontal separation is also contemplated and may be used, as is suitable, for special effect or range finding.

A detachable or built-in added camera may also include its own data storage and other capabilities. Said exemplary camera may be sensitive to non-visible or extremely low-intensity light for thermal or night vision capabilities.

A detachable or built-in optical device with “time-of-flight” optical range measuring or area scanning/ranging capability can be incorporated into the invention.

The invention can be operated with “smartphone like” devices such as Apple's iPod Touch and also tablet devices from a variety of manufacturers. These devices can be described as combining a computer with a display and integrated touchscreen in a handheld unitary package

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An apparatus for viewing the display of and inputting data to a smartphone comprising:
a holder for receiving a smartphone;
viewing optics;
user input interface; and
wireless communication means;
wherein the viewing optics provides essentially the same view to both eyes in a binocular viewing arrangement.

2. An apparatus for viewing the display of and inputting data to a smartphone comprising:
a holder for receiving a smartphone;
viewing optics;
user input interface; and
wireless communication means;
wherein input to the user input interface is substituted for the input from the smartphone's built in touchscreen.
